(19) United States
(12) Patent Application Publication
(10) Pub. No.: US 2004/0139000 A1
(43) Pub. Date: Jul. 15, 2004

(54) Advanced automatic instant money transfer machine

(76) Inventor: Carl Raymond Amos, Reston, VA (US)

Correspondence Address: Mr. Carl Raymond Amos, 1670 Bayfield Way, Reston, VA, 20194, US

(21) Appl. No.: 10/424,155

(22) Filed: Apr. 28, 2003

Related U.S. Application Data
(63) Continuation-in-part of application No. 09/565,389, filed on May 5, 2000, now Pat. No. 6,554,184.

(51) Int. Cl. G06F 17/60

(52) U.S. Cl. 705/39

(57) ABSTRACT

The Advanced Automatic Instant Money Transfer Machine, AAIMTM, system is a multiplicity of devices on a communications network available 24 hours a day, used interchangeably as sender, receiver and dispenser of funds and data. The sender accepts standard currency and includes removable medium storage devices to transfer to another such device acting as a receiver/dispenser. Remitted amounts are inserted or deducted from credit/debit accounts or currency and who pays the fees charged is indicated by an initiator of the transaction. Transfer transaction information includes: the type of transfer (money/funds or data), which device deducts the fee; how much money or what data to transfer; and to who and where the transfer transaction is to be made available. A receipt is generated by the sender via the system and a receiver becomes a dispenser only when the recipient retrieves a pending transaction using the appropriate password or identification. The cash, data, or financial instrument is then dispensed. The AAIMTMs also features voice-recognition, video, and sound to interact directly with initiator and intended recipient through video/sound, telephonic, or other communication means. Also music and music videos, will provide a dynamic and positive environment for the young and old, this feature can have a select means, enabling a user of the system to choose what they want to see and hear. A writable screen and/or digital pen means, to enable handwriting or use a signature, biometric devices, and other security features for document and money transfers give the users of AAIMTMs the added assurity that their transactions are reliable and trustworthy. The addition of audio-visual means enables a user of the system to perform transactions in real-time and generally enhance the transfer process as well as increasing safety and security requirements.

This application is a continuation in-part of application Ser. No. 09/565,389 filed May 5, 2000, titled Automatic Instant Money Transfer Machine and is incorporated by reference herein.

### BACKGROUND OF THE INVENTION

The invention is related to devices used to transfer funds or currency by electronic means. It is well known in the art that the money transfer industry requires an agent, usually a franchised store's clerk accepting cash or credit, and using telephonic or EDI means to transfer funds from one individual at a proximal location to another individual or entity at a distal location. MoneyGram, Western Union, CyberCash and others operate in this fashion.

The invention presented is not limited to requiring a physical person, telephonic means, or EDI based means to accomplish a funds transfer. Instead the invention utilizes a device that should be considered a hybrid apparatus, drawing on aspects of both a vending machine and an automated teller machine (ATM). Both are well known in the art of electronic money handling devices.

The Advanced Automatic Instant Money Transfer Machine or Aunty IM operates like a reciprocal ATM, utilizing a communications network (wired, optical, wireless, or other communications means) to transmit information between a multitude of like devices. The devices, available 24 hours a day, operate interchangeably as sender, receiver, and dispenser of funds. The Aunty IM will accept standard currency, i.e., coins and bills, in denominations of $1 to $100. Alternately, funds are entered using standard credit and/or banking card in lieu of cash at the device or through a PC over the Internet web page of the Central Database Server (CDBS) or by phone wherein the transfer network alternatively has access to any financial institution or by means known to one skilled in the art. Additionally, an ATM via system modifications can accept and send transferred funds, i.e. cash, from and to the Aunty IM system by an individual inserting and sending currency or by accessing his/her designated financial account through the ATM's network. The benefit of this inventive system is that it eliminates the high overhead of the agents, teller and/or clerks who normally supervise the transfer transactions. The enormous fees arbitrarily imposed by such behemoths as Western Union, MoneyGram and similar entities are greatly reduced or eliminated because a human agent is not required. The other benefit is that the Aunty IM transfers funds to individuals unlike an ATM's one way dispensing of funds and which only transfers money to other specified accounts. The addition of music and music videos, jingles and tunes will provide a new dimension to the system and industry enabling a more calm, relaxing, cheerful environment and experience with all AAIMTM's.

### SUMMARY OF THE INVENTION

The instant invention is an improvement over previous devices, methods, and systems used to transfer currency or funds by electronic means. At his or her discretion the user is able to transfer or receive money (using cash, credit, debit or bank cards financial instruments and/or biometric technology) to a distal location or receive money from a proximal location anytime. The addition of audio, voice-recognition and voice and sound prompts, provides a more versatile universal system. The addition of video and Internet video means, cameras, streaming video and methods known to those skilled in the art. Including the ability to talk and see directly with intended recipient and/or designee through telephonic or other communication means. The use of a visual/video means and a writable screen, pen/write, or digital pen technology means further adds authenticity to letters, messages, and documents. This will enable a user of the system to perform some transactions in real-time and generally enhance the transaction as well as increasing safety and security requirements. The addition of music and music videos( with optional selection means) new and old of all types and diverse nationalitys and ethnicitys will provide a unique experience and enhance the money transfer process. Holographic 3D optics, optical, and visual technologies known to those skilled in the art, including icons, holodecks, computer, and digital technology can create cyber space virtual agents and/or environments that will help users of the system to accomplish a more secure, low cost, and efficient funds transfer.

This improved system is capable of accessing and interacting with financial institutions both nationally and globally allowing the machine, method, process, and system to be more robust and universal. The system allows for appropriate currency conversions using the correct rates, that is the Euro vs. the US dollar, etc., and adheres to the proper government laws and restrictions for different countries. Most conventional ATM's and systems can be redesigned, reengineered, modified, and retrofitted to function as an Advanced Automatic Instant Money Transfer Machine or AAIMTM. The modified system can still possess some basic rudimentary ATM functions if desired.

The instant invention is not limited to telephonic means or EDI based methods to accomplish a funds transfer. The system is not restricted to modems or microprocessors for transmission of information and processing. Optics and optoelectronic technology as well as Internet and satellite communication and other methods known to those skilled in the art may be employed. Virtual private networks (VPNs) can be employed. Encryption and other security methods known to those skilled in the art are employed to achieve confidential and secure communications.

### BRIEF DESCRIPTION OF THE SEVERAL VIEWS OF THE DRAWINGS

The following illustrations of the system architecture and the means are not limited thereto other embodiments known to those skilled in the art providing efficiency can be employed. The patent or application file contains at least one drawing executed in color. Copies of this patent or patent application publication with color drawing(s) will be provided by the Office upon request and payment of the appropriate fees.

FIG. 1: AAIMTM Internal Network Logical Data Flowchart details the data elements of the system.

FIG. 2: AAIMTM/External Network Logical Data Flowchart details accessing an external network.

FIG. 3: Alternate PC/AAIMTM INS Logical Data Flowchart details access by a PC or similar device.

FIG. 4: Advanced AIMTM Embodiment A depicts a basic Advanced Automatic Instant Money Transfer Machine.

FIG. 5: Advanced AIMTM Embodiment B is an illustration of an AAIMTM with a speaker and microphone.

FIG. 6: Advanced AIMTM Embodiment C is an illustration of an AAIMTM with a camera lens.

FIG. 7: Advanced AIMTM Embodiment D shows an AAIMTM with biometric scanning and biometric means.

FIG. 8: Advanced AIMTM Embodiment E shows an AAIMTM with multiple interfaces.

FIG. 9: Advanced AIMTM Embodiment E depicts another instance of a multi-access AAIMTM.

FIG. 10: Workflow Chart A is an illustration of AAIMTM system processes.

FIG. 11: Workflow Chart B is an illustration of the AAIMTM system interacting with its Central Database Server.

FIG. 12: Workflow Chart C illustrates the AAIMTM system interacting with an external financial institution's network.

FIG. 13: Workflow Chart D illustrates the AAIMTM system interacting with a standalone Internet kiosk.

### DETAILED DESCRIPTION OF THE INVENTION

U.S. Pat. No. 5,963,647, No. 5,825,003, and No. 5,982,918 that are incorporated herein by reference can be greatly improved and enhanced by using the teachings of the instant invention, so as to provide a more versatile, universal and dynamic system(s) that can be used by all peoples of the world. These improvements are especially useful to the poor and middle class who regularly are being phased out of the banking system of now and the future. Eclipsing and revolutionizing the art, the system is able to interface and interact with ATMs, customer activated terminals (CATs), and similar banking/financial kiosks. The addition of video cameras and the like will enable appropriate government 'institutions, i.e., NSA and others, to monitor the system in real-time to encourage compliance with all government laws and regulations both nationally and globally.

The instant invention, as described and illustrated herein, is a money transfer process and device consisting of a cash accepting/dispensing devices, coin accepting/return device coupled to a display unit (which may include a touch screen or pen-write display), data input devices and a printer/dispenser that uses a computer/microprocessor and a modem and/or transceiver means for control and communication to multiple such devices [A1-n, B1-n] and/or a centralized database for transactions, accounting, and inventory control. A multiplicity of the devices on a communications network, be it telephonic, wireless, etc., is available 24 hours a day, as sender, receiver and dispenser [A or B] of funds interchangeably. A Receiver (AAIMTM B) becomes a Dispenser when the Recipient (a person) retrieves the pending transaction that was originally sent by initiator or sender from device A (AAIMTM), the Recipient uses a verifiable password or identification. Obviously, it is theoretically possible for the intended receiver to retrieve his money from the device, AAIMTM A, if by chance he is in the vicinity of AAIMTM A. All that is required is to merely input his verifiable password, identification, or biometric means. However, if the payment of the transaction fee is paid at the reciever/dispenser, then, when prompted by the reciever/dispenser, the additional information is inputted indicating to the device whether to deduct the fee from the transferred funds or the fee will be remitted by the Recipient.

The AAIMTM employs I/O devices, such as CD-ROM, CD-RW, DVD, scanners, diskette drives, and/or any other associated technology known to those skilled in the art. A writable screen, digital pen, and/or other means known to those skilled in the art can be employed to enable handwriting or to use a signature for documents and generally for any or all money transfer. This will enhance security and increase versatility. Biometric capabilities and an expanded output means facilitate cash/funds and data transfers. Various geometric shapes of the kiosk containing the machine may be employed to eliminate long lines, i.e., cubic, spherical, cylindrical, and pyramidal, etc. A cubic shaped kiosk allows for example up to four (4) users to simultaneously access the system, since each vertical face of the cube contains a machine.

The addition of Audio, Video and Voice-Recognition (AVRCG), sound/voice (S/V) technology, and/or video, data streaming, and/or live-feed technology facilitate use of the machines and enhance man-machine interaction, enabling real-time money transfers. AVRCG and SN prompts in different languages and diverse dialects will aid in the understanding and use of the system. A user can see and hear instructions and give commands to be led or spoon fed through the process. Maps and charts on the display along with GPS technology aid in the process.

Genetic technology including DNA technology, biochips and genetic programming can be employed. Melanin based chips and circuitry, neural networks as well as Brain Machine Interface (BMI) and other technologies including psionic or telepathic systems/processes ideally suited for paraplegics and others with impairments can be employed.

The technology of magnetic-spin processing and circuitry, or spintronics and nanotechnology, can be employed. Quantum information science, quantum processing, quantum-dots/programmable matter, and quantum teleportation methods, schemes, and systems can be utilized in this system. The process or phenomenon known as entanglement and the ability to create and use quantum states to create cryptographic keys that are virtually immune or impervious to eavesdropping or hackers is ideally suited for this system. In quantum processing and quantum teleportation, 1s and 0s, or bits, are represented instead by superimposed quantum states or Q-bits and E-bits. A type of quantum teleportation scheme or process can be demonstrated wherein information and data (or money) is quantum teleported. Quantum information science, quantum computing, quantum cryptographic keys and algorithms, and quantum teleportation methods and schemes will enhance the process and achieve the goal of efficient and secure money /data transfers (see Scientific American, vol. 13, no. 1, © 2003, incorporated by reference herein).

Secured information or data may also be encrypted and transmitted. Appropriate security software can be used and Virtual Private Networks (VPNs) may be utilized. This information includes but is not limited to: insurance information and records; business data and records, billing information; medical information, data and records; credit information, data and record(s) and generally any confidential or personal information. Also, the device can interface with the Internet to allow a user to pay for goods and services with real currency and or credit or debit cards and various financial instruments, this can be enhanced especially if quantum teleportation methods, schemes and processes are used. A user of the system can engage in Internet or online casino gambling, lotterys, and pay-as-you-go sites.

The system is also capable of supporting an on-line stock market that would be a type of cyber space securities and exchange, stock market, or virtual stock market, wherein securities and various financial instruments could be bought or sold. Essentially it can be a cyber or virtual wall street. Airline tickets, bill payment and check cashing can also be accomplished by this system. The ubiquitous use and acceptance of personal computers (PCs) has revolutionized modern commerce.

However, Internet commerce can often be financially risky and dangerous. Fraud is rampant once credit or debit card information is entrusted to strangers. A possible expedient is to borrow some of the teachings of the instant invention and reengineer and modify a PC or laptop to contain a bill accepting means, bill dispenser, and/or coin accepting, as well as include card scanners or readers for credit card/debit cards and various financial instruments. The money of course is stored in a cache strongbox, which could be a sort of drop safe or escrow at the users PC or laptop, home or place of business and at a predetermined or agreed time it can be serviced.

Another expedient in the same line is to reengineer or modify and enhance a bill acceptor and coin acceptor with appropriate hardware and circuitry as well as software. So that this hybrid bill acceptor or cash acceptor/receiver is versatile, portable (can be carried around), and able to interface with PCs and laptops and networks. This can serve as a type of mini bank, mini safe or portable bank, allowing for practical commerce on the Internet and other super information highways.

Optional features include but are not limited to:

Post/future dated retrieval of money/data transfers;

Maximum wait time (MWT) to retrieve transferred funds/data, when the MWT elapses the funds/data are returned to the Initiator or a Designee; Music and music video select means.

Global accessibility to transferred funds and partial payment of the transfer fee is optional.

Compatibility to any network or networking architecture and/or protocols for communications between devices A and B, the CDBS or other financial institutions network will be utilized;

Functions for transactions and printing/cashing money orders, checks, financial instruments, i.e., smart cards.

Money market(s), stocks/bonds, tickets (transportation, entertainment), bills, etc.;

Check cashing services with passwords/codes; Writable screen /pen/write digital pen technology and means

Dunce's guide to money transfers (a tutorial on how to utilize the Aunty IM system);

Handicapped patron options (including voice recognition, Braille, TDD, etc.).

### DETAILED DESCRIPTION OF THE DRAWINGS

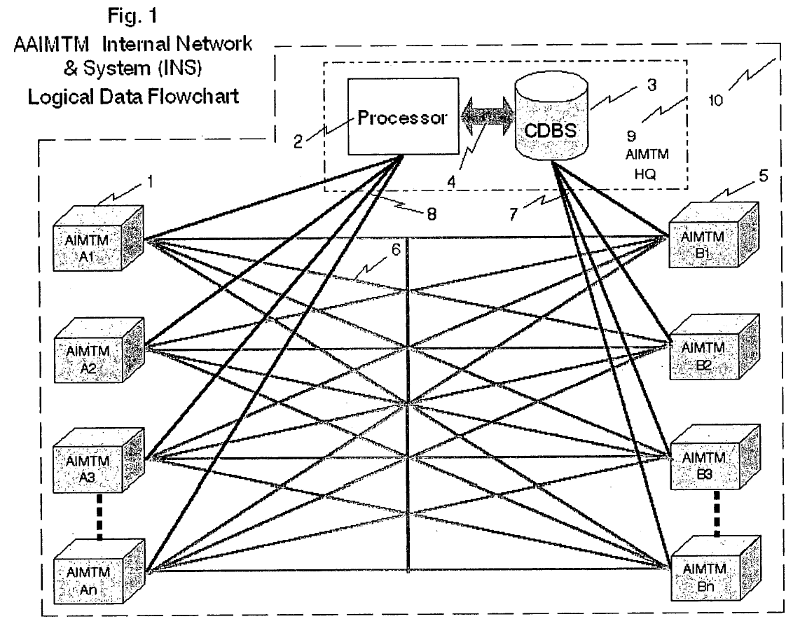

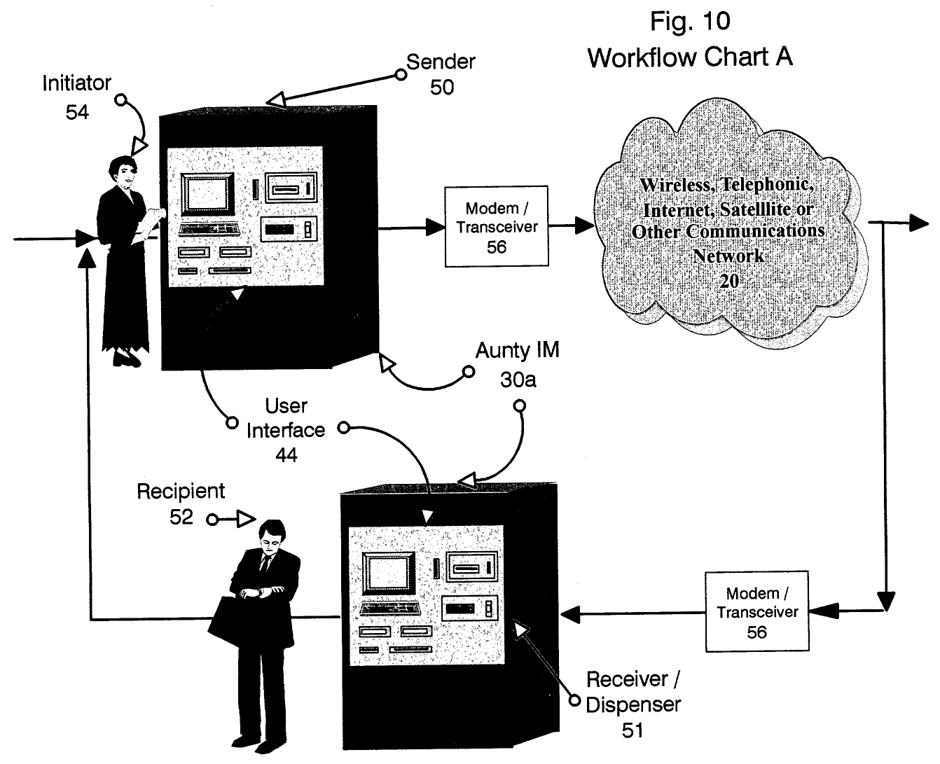

FIG. 1 is an illustration of an AAIMTM Internal Network and System (INS) [10] logical data flow showing a series of AAIMTMs on a network. The series of AAIMTMs are capable of transfers from a proximal location(s) [1], AAIMTMs or devices A1-An, to distal location(s) [5], AAIMTMs or devices B1-Bn, via the AAIMTM internal network [6] (in blue). Each AAIMTM has the capability to be in direct communication with every other AAIMTM in the series A and B. As discussed above, any AAIMTM is interchangeably at a proximal and/or distal location depending on whether an initiator [54] or a Recipient [52] (not shown on this diagram, see FIG. 10) starts a process. FIG. 1 is intended to give a logical representation of where data is sent in the AAIMTM INS [10]. Each AAIMTM is capable of sending and receiving signals and data with or without a centralized network controller and is capable of tracking transactions, inventory and other operations data as necessary. This method of communication is well known to those skilled in the art as a “neural network” or mesh.

Another embodiment in FIG. 1 is that signals from the series of AAIMTMs [1] are routed to a processor [2] or alternately directly to a central database server (CDBS) [3] to do required day to day functions including end-of-day processing and/or track transactions on the internal network [6]. Both proximal AAIMTMs [1] or distal AAIMTMs [5], as needed, route traffic to processor [2] using transmission paths [8]. (Transmission paths [8] are not shown in this diagram connecting AAIMTMs [5] to CDBS [3]; however, it is understood that this can occur.) The processor [2] proceeds to transmit and receive data via signal path [4] to and from the CDBS [3] shown all together as AAIMTM HQ [9]. The processor [2] may function as a front end, a demilitarized zone (DMZ), or as a host for the CDBS [3]. The trusted transmission paths [7] allow each proximal AAIMTM [1] or distal AAIMTM [5] to directly connect to the CDBS [3] as the situation merits. (Transmission paths [7] are not shown in this diagram connecting AAIMTMs [1] to CDBS [3]; however, it is understood that this can occur.) The transaction accounting and tracking of funds is handled by the CDBS [3], which also allows for data mining of current and past trends in usage, inventory, and/or other database functions well known to one skilled in the art.

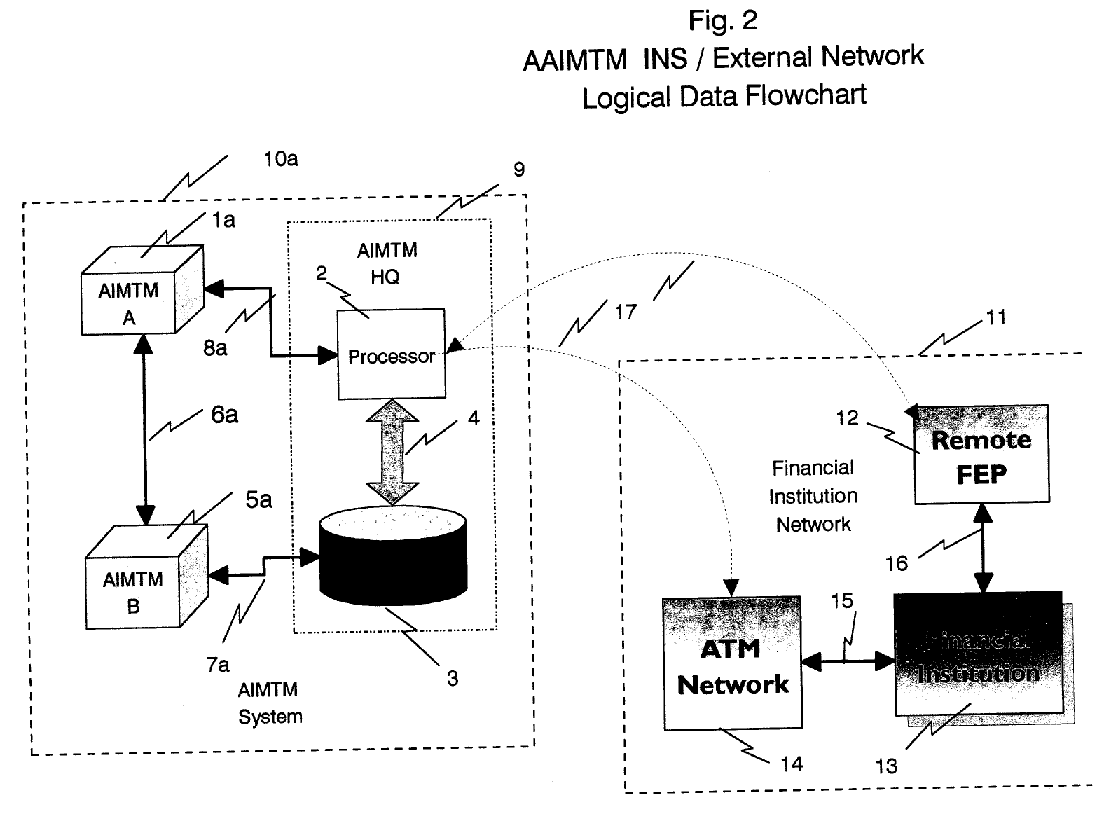

FIG. 2 is an illustration of the AAIMTM /External Network Logical Data Flowchart detailing an AAIMTM INS [10] accessing and communicating with a financial institution's network (FIN) [11]. For convenience the AAIMTM INS [10] of FIG. 1 is shown compressed as element [10a], wherein devices A1-An [1] are represented AAIMTM A [1a], devices B1-Bn [5] are represented as AAIMTM B [5a], the internal network [6] is shown as a logical network path [6a], transmission paths [8] are now a logical transmission path [8a], and trusted transmission paths [7] are now a logical trusted path [7a].

FIG. 2 shows external transmission paths [17] which allow AAIMTM HQ [9] access to a FIN [11] through the FIN's remote front-end processor [12] and/or it's ATM network [14]. Logical networks [15] and [16], shown only as a convenience to this discussion, are part of the FIN [11]. This arrangement in turn permits the plethora of parent banks' mainframes and ATM networks a single contact point processor [2] in the AAIMTM INS [10] through their associated logical networks [15 & 16]. Any AAIMTM is capable of interfacing and communicating with virtually any bank or FIN worldwide.

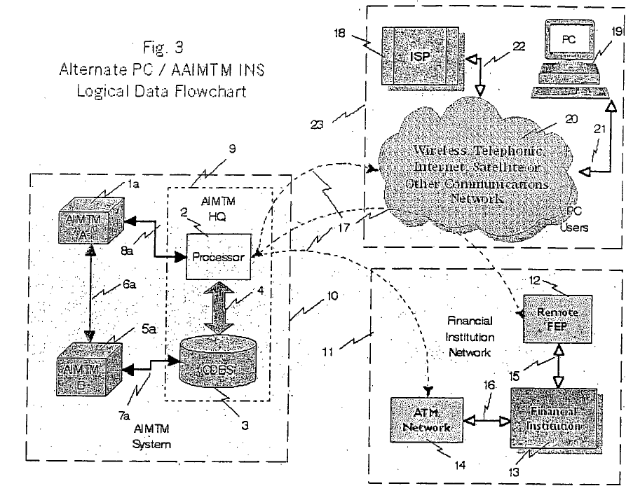

FIG. 3 embodies an alternate PC/AAIMTM INS/External Network Logical Data Flowchart detailing an AAIMTM INS [10a] that is accessed by a PC [19] (or similar Internet connection device). The external transmission paths [17] and logical transmission paths [21] and [22] are only representational of either satellite, wireless, wired (telephonic), Internet and/or any other communications means [20] known to those skilled in the art. The PC accesses the AAIMTM web page (not shown) via logical transmission path [21] to connect to an Internet Service Provider (ISP) [18] or directly to AAIMTM INS [10a] via an external transmission path [17]. The ISP [18] uses its own logical transmission path [22] to connect through to the AAIMTM INS [10], usually through the Internet or any communications means.

The AAIMTM HQ [9] acts as an intermediary that interfaces and communicates with a distal FIN [11] to send account information (credit or debit) and receive acknowledgment of the availability of funds to be transferred. Then the AAIMTM HQ [9] transmits the proper transaction information to both the PC and the appropriate individual AAIMTMs as receivers and potential dispensers of funds. The AAIMTM INS [10a] transmits a confirmation/receipt of the transaction on screen, via email or snail mail of which a PC user [23] receives.

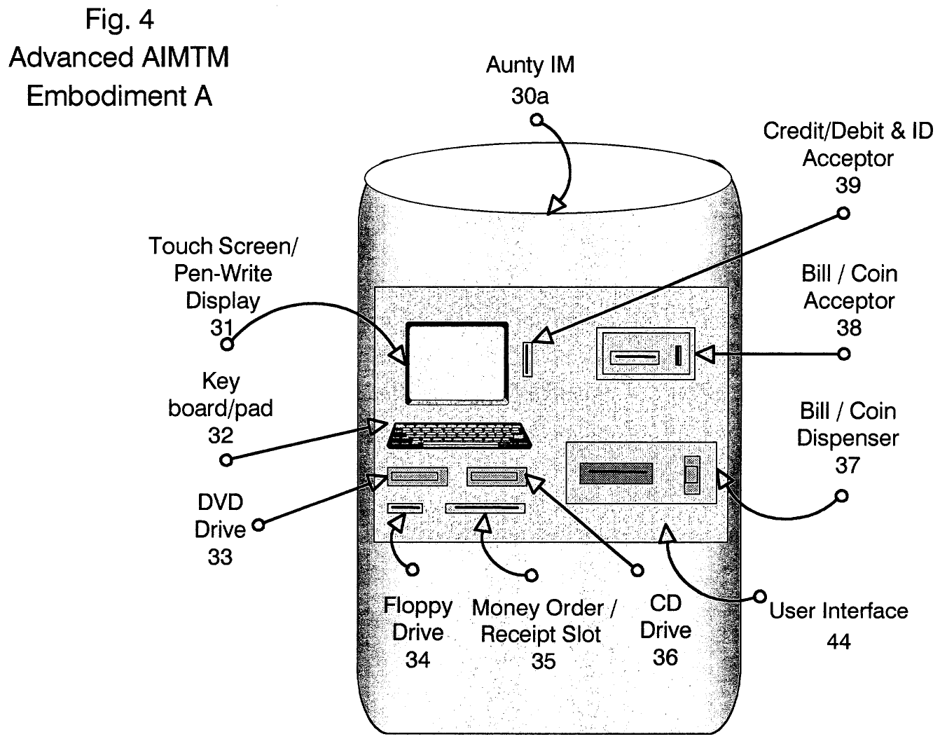

FIG. 4 illustrates the Advanced AIMTM Embodiment A is an illustration of a basic Advanced Automatic Instant Money Transfer Machine. In this drawing only one face is depicted; however, multiple interfaces can be added to this system or machine so that several people can simultaneously access the AAIMTM. The AAIMTM or Aunty IM [30] comprises (besides the housing): a touch screen, writable screen, pen-write display, and/or digital pen means [31] and/or keypad/keyboard [32], a slot [35] for money orders, receipt and/or other financial instruments, a bill/coin dispenser [37], a bill/coin acceptor [38], and a credit/debit & id acceptor [39]. What is also included to the Aunty IM [30a-d] are DVD drives [33], a floppy drive [34], and a CD drive [36] (read or read/write) as part of the user interface. Also in the Aunty IM [30], which is not shown but is included and not limited to, are bill collators and stackers, a receptacle for temporarily hold bills and coins, a safe for fee deposits, and reservoirs for bill and coin dispensing, plus those elements discussed in application Ser. No. 09/565,389.

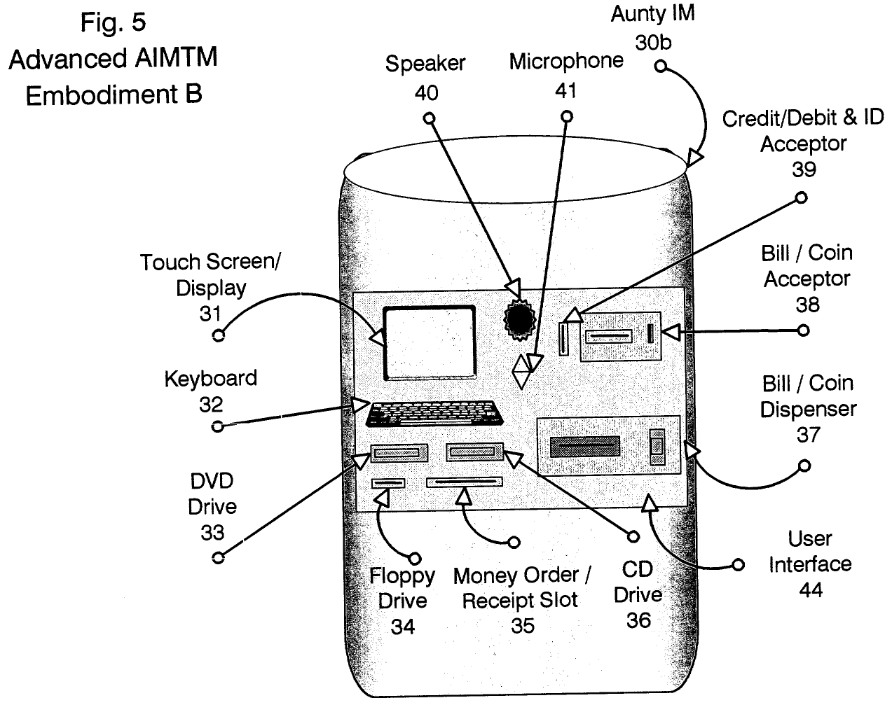

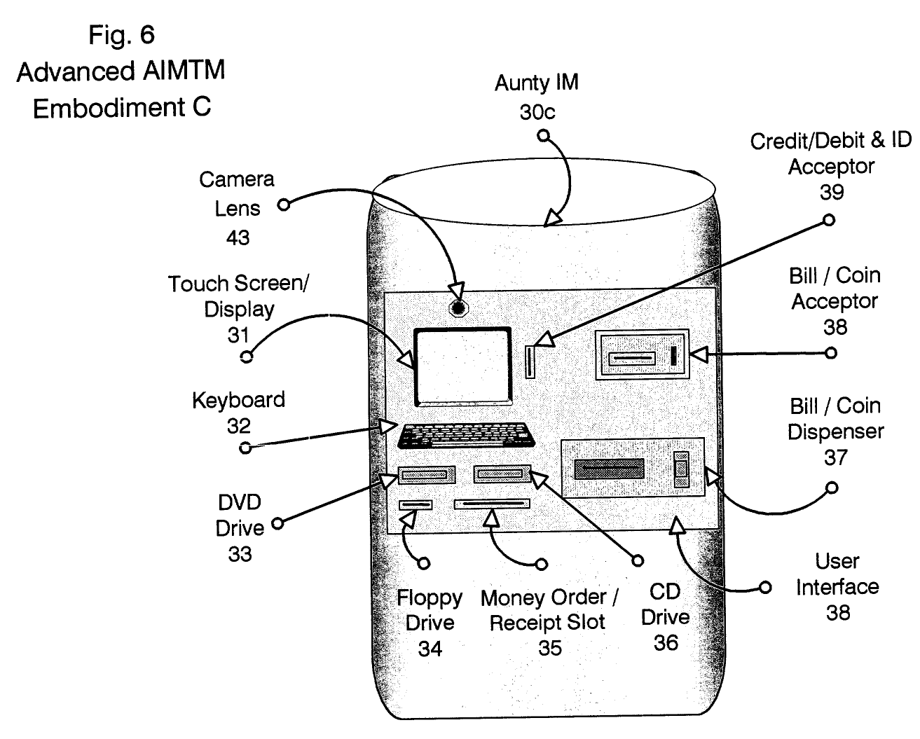

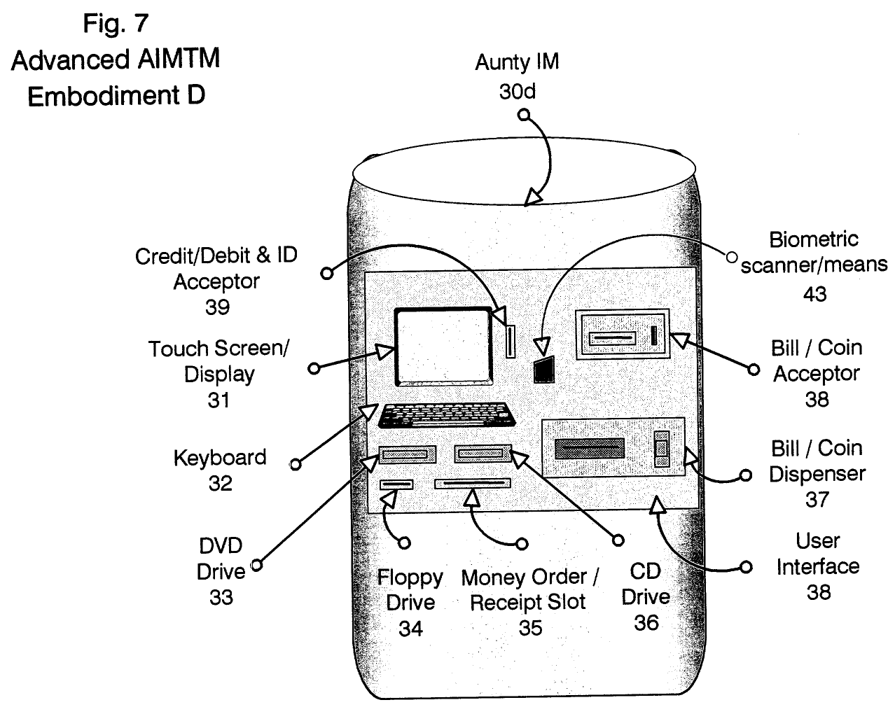

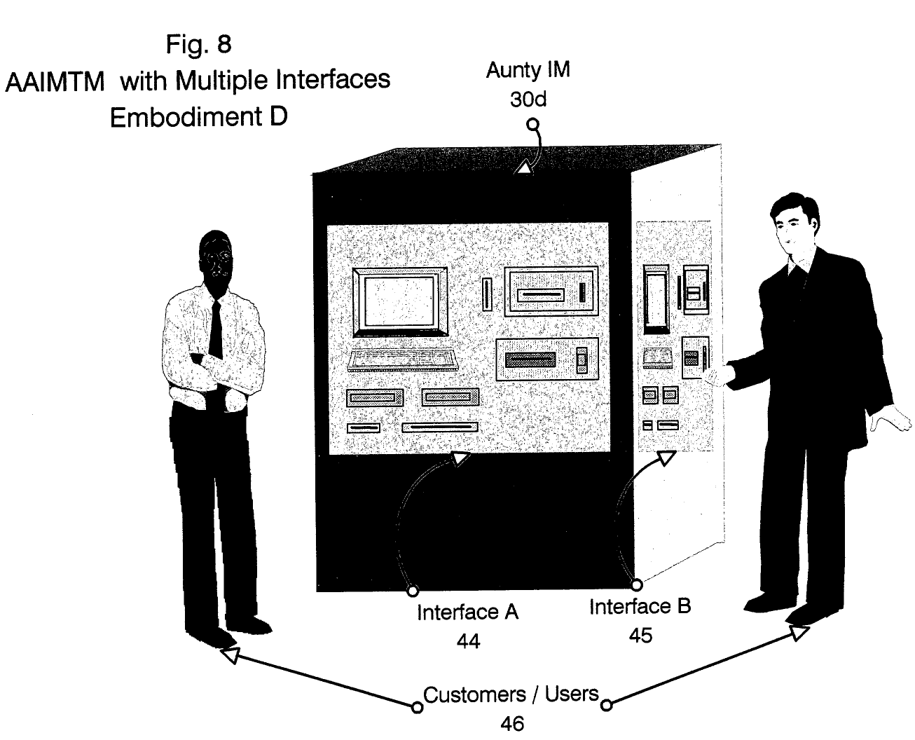

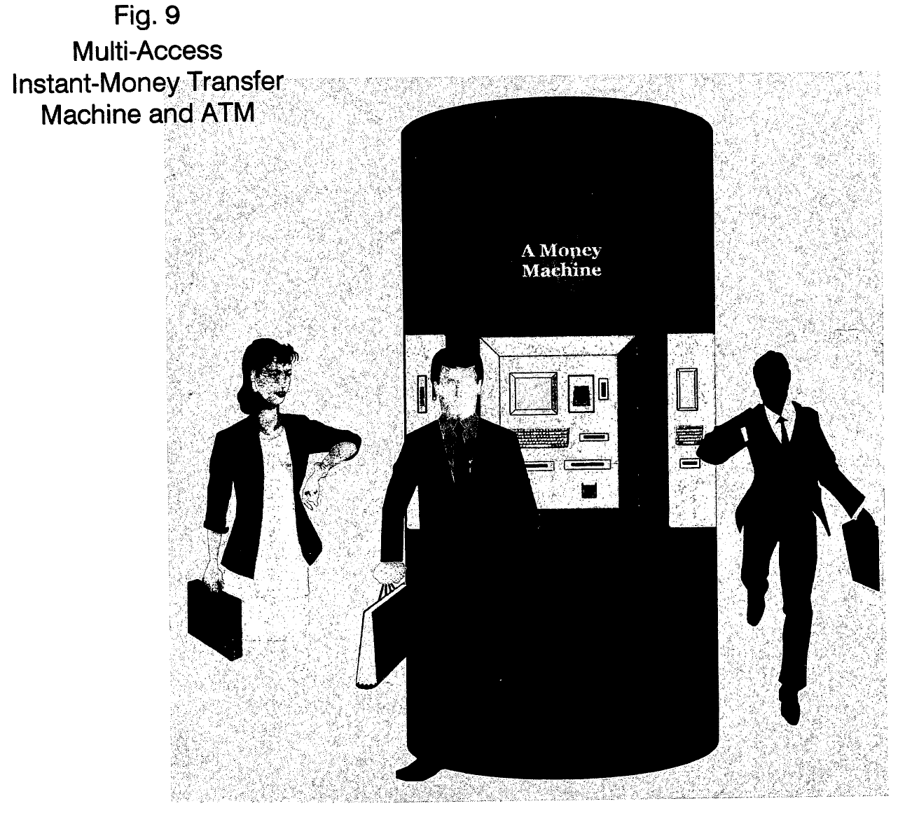

FIGS. 5, 6, and 7 illustrate Advanced AIMTM Embodiments B-E all of which includes all elements in AAIMTM [30]. FIG. 5 shows Embodiment B that includes a speaker [40] and microphone [41] for audio interfacing and interaction as described above under “Detailed Description of Invention”, FIG. 6 displays Embodiment C that includes a camera lens and/or video interface means [43]. FIG. 7 shows Embodiment D that has biometric scanner/means. FIGS. 8 and 9 depict Embodiment E that includes multiple interfaces [44] and [45] enabling multiple users [46] access to Aunty IM [30e] transfer functions whereas FIG. 9 Aunty IM [30e] is cylindrical in shape.

This next discussion delineates the transfer procedure that is common to all Embodiments A-E in FIGS. 1-11, the set of processes is designated all together as transfer transactions. As discussed in application Ser. No. 09/565,389, it is as follows:

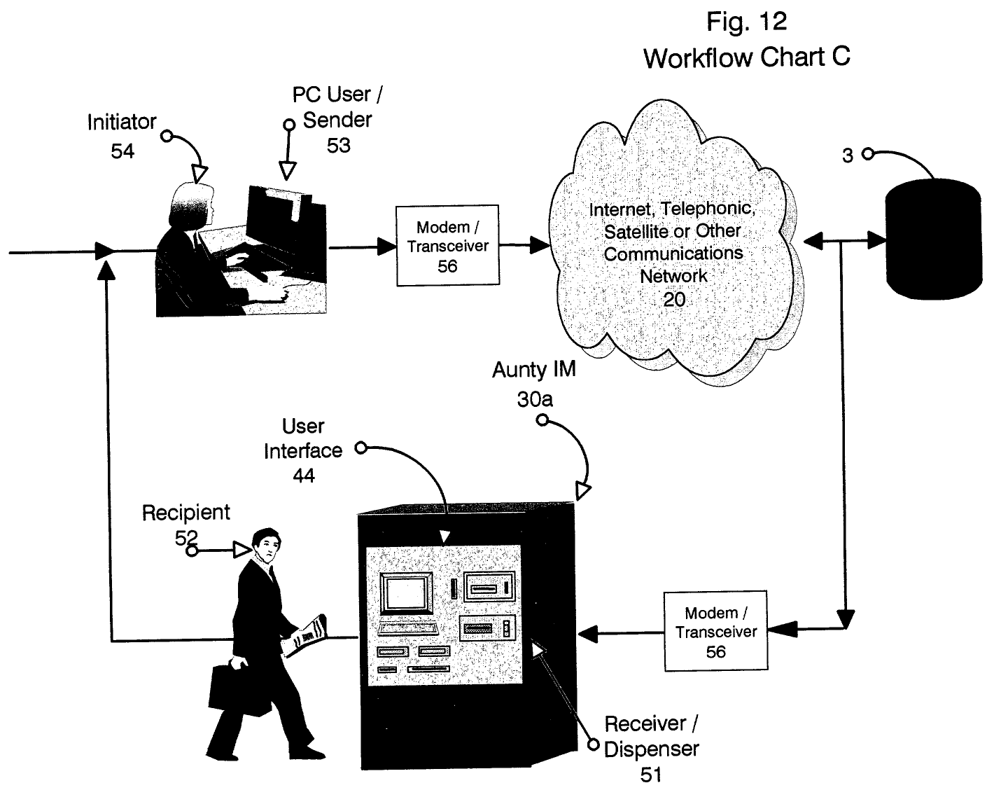

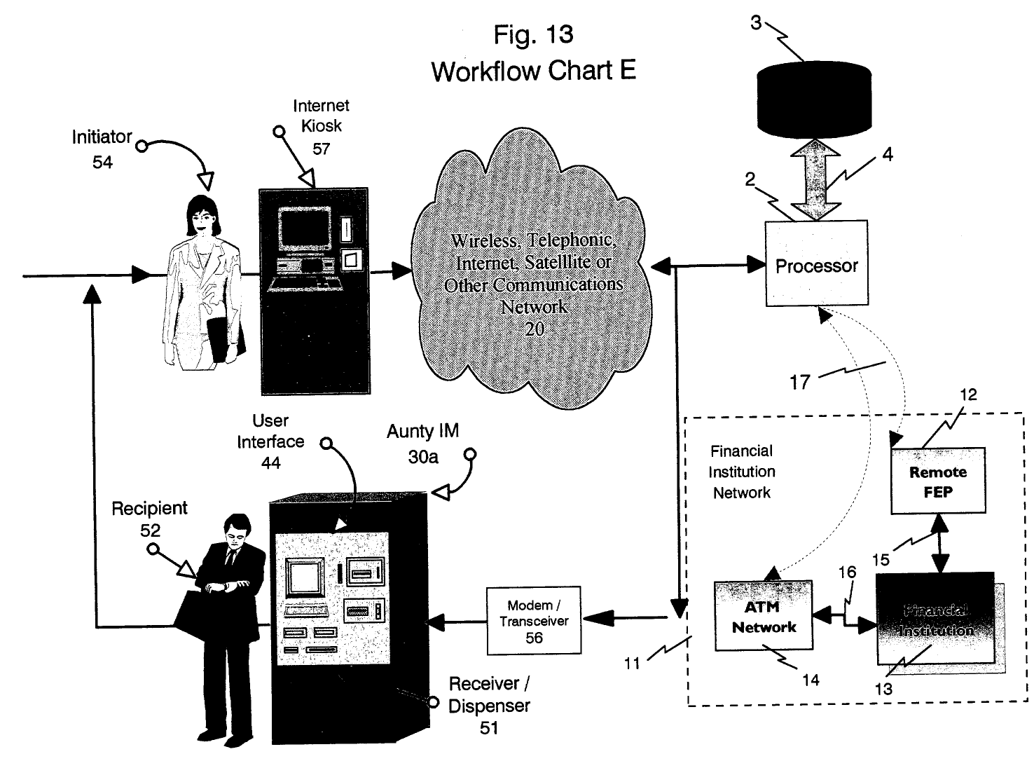

The Sender [50], device A [1], indicates a transfer is desired creating (via system) a pending transaction generated from the transfer information. The transfer information consists of who pays for the transfer (Initiator [54] or Recipient [52]), identification data about the Recipient (to whom), and identification data about the location(s) (to where) the funds are to be made available to device B (or devices B1-n [5] at multiple sites). The e money to be sent and optionally the applicable fee is inserted into the bill/coin acceptors [38] at device A and is verified against the keypad/keyboard [32], or touch screen [31] input amount. A password is then either inputted by the Initiator [54] or generated by sender [50] (or via system) to give to the Recipient [52] by phone or other means and added to the pending transaction. The transaction information is verified by the Sender [50], device A, with the Initiator [54]. A first set of signals consisting of the pending transaction information is transmitted via modem/transceiver [56] through communications network [20] (or combination of transmission paths [6-8]). An optional receipt is then generated by the printer through the dispenser (receipt slot) [35] for the Initiator [54]. Alternatively a cookie, email or by means known to those skilled in the art is given to the Initiator's or Agent's PC [19] to verify the transaction via the CDBS [3] or Internet web page, see FIGS. 12-13.

The Recipient [52], notified as mentions above, at a Receiver [51], device B1, proceeds to retrieve the funds through device B1 indicating a retrieval is desired using the password. The information is verified by device B1 (Receiver [51]) which now becomes a Dispenser [51]. However, if the payment of the transaction fee is paid at Dispenser [51], then, when prompted, the additional information is inputted at keypad/keyboard [32] or touch screen [31] indicating to the Dispenser [51] whether to deduct the fee from the transferred funds or the fee will be remitted (fed into the bill/coin acceptor [38]) by the Recipient. A second set of signals consisting of retrieval transaction information is transmitted back to the CDBS [3] and/or device A (Sender [50]) or financial institution [11]. The CDBS [3], financial institution [11], device A (Sender [50]), or device B1 (Dispenser [51]) cancels the pending transfer transaction indicating the funds are no longer available to other sites, devices B2-n [5], when the second set of signals is received. Then the currency is dispensed minus any applicable fee. The nominal fee that may include appropriate taxes is charged at either or both ends of the transaction.

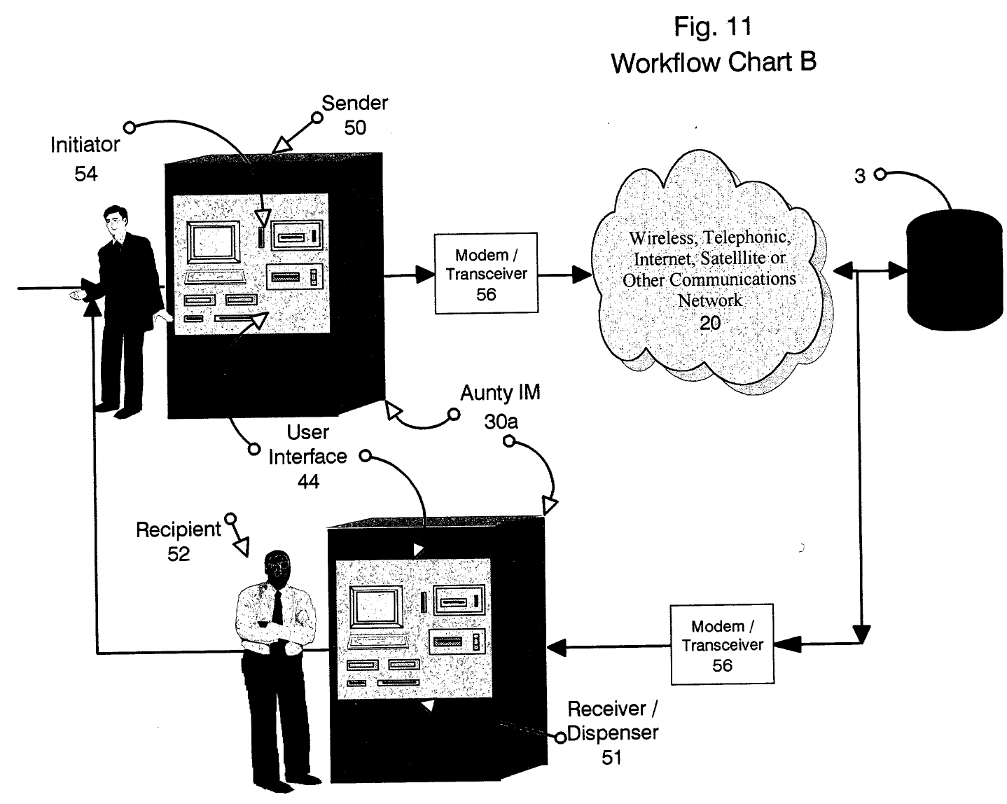

FIG. 10 shows Workflow Chart A is an illustration of AAIMTM system basic transfer transaction processes, which also are the process of FIGS. 11-13. The Initiator [54] starts the process on the first interface [44] which then causes the Aunty IM [30a] to become the sender [50]. The Initiator [54] then follows the procedure to create a transfer transaction. When the funds to be transferred (as cash, credit or debit) are verified, the transfer transaction is transmitted by the appropriate signals via the first modern/transceiver [56] using an Internet, satellite, telephonic, wireless or other communications means [20]. The second modem/transceiver [56] then transmits the transfer transaction to the receiver/dispenser [51]. Through the second interface [44], the Recipient [52] starts a receiving transaction process on receiver/dispenser [51].

What is also new in this transaction process shown in FIGS. 10-13 is user access to the additional devices the AVRCG and S/V prompts and direct video allowing for possible real-time transactions and interaction from both proximal and distal ends: DVD drive [33], floppy drive [34], and CD drive [36] and more (see FIG. 4). The Initiator [54] and Recipient [52], collectively now referred to as the user/customer [46], can upload and download data to be handled and transferred much in the same manor as money transfer transactions. Whereas instead of indicating on an initiated transaction as a money transfer, the customer [46] indicates a data transfer from a DVD, Floppy or CD drive or other means. The fee for this type of transfer is a surcharge based on the amount of data sent.

All data transfers will be secure in the transfer of packets across the AAIMTM INS [10] and any external network, since security is basic to all money transfers and ATM transactions and is well known to one of average skill in the art. However, additional safeguards are needed. With the addition of potential hacker activity and denial of service attacks on the new input devices [33], [34], and [36] data handling will be carried out in a manner similar to private intranets receiving data from the Internet. Use of a mini security zone, called a demilitarized zone (DM) known to those of average skill in the art, with packet sniffers, intrusion detection devices or agents, and anti-virus programming, would ensure protection of or significantly reduce the advent of adverse/hostile activity to the AAIMTM [30], the AAIMTM INS [10], and third party recipients of the secured money/data transfer, including quantum crytographic keys and associated technology.

FIG. 11 illustrates Workflow Chart B is an illustration of an AAIMTM system interacting with its Central Database Server (CDBS) [3], as in the description for FIG. 1. FIG. 12 shows Workflow Chart C that illustrates an AAIMTM system interacting with an external financial network through the processor, whereas the sender is utilizing a financial institution or terminal and or PC, as in the description for FIG. 2, to send money from their proximal location to a distal location. FIG. 13 embodies Workflow Chart D, illustrating the AAIMTM system interacting with a standalone Internet kiosk, as in the description for FIG. 3.

Various preferred embodiments of the invention have been described herein. It should be recognized that these embodiments are merely illustrative of the principles of the present invention. Numerous modifications and adaptations thereof will be readily apparent to those skilled in the art without departing from the spirit and scope of the present invention. Accordingly, the invention is only limited by the following claims.

What is claimed is:

1. A money transfer system that comprises a plurality of data and money transfer devices, each of said money transfer devices comprises: currency accepting means for bills and coins, a currency dispensing means for bills and coins; a data input means; an output means; a display means; a keyboard means; at least one removable media I/O device; credit, debit and identification acceptor means; the system further comprises a computing means which includes at least one microprocessing means and a modem or transceiver means for controlling communication directly between a plurality of data and money transfer devices.

2. The system of claim 1, wherein each of said data and money transfer devices includes quantum computing means and quantum cryptographic key generating means.

3. The system of claim 1, wherein each of said data and money transfer devices includes pen-writing or digital pen means.

4. The system of claim 1, wherein each of said data and money transfer devices includes speaker means, microphone means, voice recognition means to enable the system to interact with the user in any language and to facilitate usage of the system.

5. The system of claim 1, wherein each of said data and money transfer devices includes video means, video data streaming means, and camera means for visual interaction and visual recognition to facilitate usage of the system.

6. The system of claim 1, wherein each of data and money transfer devices operates as a sender, receiver and dispenser of funds interchangeably.

7. A system of claim 1, wherein the data to be transferred includes: insurance information and records; business data and records; billing information; medical information, data and records; credit information, data and records and generally any confidential or personal information,

8. The system of claim 1, wherein data or money is inputted into a proximal data and money transfer device and electronically causing the dispensing of like data or money at a distal data and money transfer device.

9. The system of claim 1, whereby currency or money amounts are transmitted over distances reciprocally to similarly interconnected web of data and money transfer devices whereby inserting currency at a proximal end will cause dispensing of like funds at a distal end.

10. The system of claim 1, whereby the data to be transferred is transmitted over distances reciprocally to similarly interconnected web of data and money transfer devices whereby inputting data at a proximal end will cause dispensing of like data at a distal end.

11. The system of claim 1, wherein each data and money transfer devices utilizes a communications network between distal and proximal ends.

12. The system of claim 1, wherein the system further comprises a central database server means to record transactions and for accounting and inventory control.

13. The system of claim 1, which each data and money transfer devices further comprises a biometric means to identify both an initiator and/or recipient.

14. The system of claim 1, wherein the system is able to interface with any conventional or non-convential automated teller machine, customer access terminal, and global financial networks or automated teller machine networks to efficiently transfer money, messages and data.

15. The system of claim 1, wherein the currency accepting means include recycling means to dispense money accepted as funds to be transferred.

16. The system of claim 1, wherein the system uses currency, credit or banking cards at the data and money transfer devices or through a personal computer or the central database server means and accesses proximal and distal financial institutions to either get transfer transaction funds and/or funds to pay for a transaction.

17. The system of claim 1, which includes automated teller machine system modifications to accept transfer transaction funds from said data and money transfer devices and send said funds to said devices, by a user accessing a designated financial account or without accessing said designated account using said currency accepting means, through an automated teller machine network, the Internet or other communication means.

18. A method of data and money transfer between a pluarlity of data and money transfer devices, each of said data and money transfer devices at a proximal end transmits information utilizing a communications network on a transaction to be completed at a distal end:
a. the transaction information comprises:
i. a recipient identification data,
ii. a designated distal end or general locality,
iii. what transfer type is to be made, either data or money:
1) if the transfer type is data, then the file name and file format is included,
2) if the transfer type is money, then amount of funds in the transaction is included, and what type of funds is to be made available to one or more data and money transfer devices at said distal end,
iv. what type of funds has been accepted by the data and money transfer device, whether currency, credit, or debit,
v. which end of the transaction pays for the transaction, distal or proximal ends,
vi. confirmation and transaction codes and a password;
b. wherein said money transfer device designations comprise:
i. each data or money transfer device is either a sender or a receiver or a dispenser data and money transfer device interchangeably, depending on whether the data or money transfer device is on the proximal or distal end of said transaction,
ii. said data and money transfer device becomes the sender by initiating said transaction,
iii. said data and money transfer device becomes the receiver by receiving a signal that said transaction is pending in said designated general locality,
iv. said receiver becomes the dispenser only when one data and money transfer device at the general locality indicates a retrieval of a pending transaction;
c. wherein said transaction transpires in the following manner:
i. when a transaction initiation signal is generated, said transaction information is prompted to be entered into said sender data and money transfer device on the proximal end,
ii. the sender data and money transfer device generates a confirmation code and prompts for said password, if said password is not entered then said password is internally generated,
iii. said sender data and money transfer device verifies all said transaction information,
iv. said transaction information is then encrypted for transmittal,
v. said sender data and money transfer device generates a receipt,
vi. a first set of signals is sent to said distal end or designated general locality for receiver data and money transfer devices,
vii. an input signal is received by the receiver data and money transfer device to indicate a retrieval of a pending transaction,
viii. the password and retrieval information is inputted to the receiver data and money transfer device to initiate the retrieval,
ix. the transaction information is verified by the receiver data money and transfer device, which then becomes the said dispenser data and money transfer device,
x. a second set of signals is transmitted back to the sender data and money transfer device to indicate the pending transaction is no longer available,
xi. dispensing is done according to the transfer type in the transaction information:
1) if the indicated transfer type is for data, then the file is transmitted to a removable media I/O device,
2) if the indicated transfer type is for money, said amount of funds are dispensed according to the transaction information.

19. The method of claim 18, wherein said transferred funds are dispensed as currency or financial instruments.

20. The method of claim 18, wherein said currency accepted into the data and money transfer device is recycled into a currency accepting means or a coin accepting means as funds to dispense.

21. The method of claim 18, wherein the transaction information includes whether the proximal or distal end of the transaction pays or provides the transaction fee.

22. The method of claim 21, wherein the transaction fee is acquired by either currency, debit or credit using any conventional or non-convential automated teller machine network, the Internet or other communication means:
a. if debit or credit is indicated to acquire the transaction fee, then interfacing with any designated financial institution to access a designated financial account,
b. if currency is indicated to acquire the transaction fee, then depending on the transaction information, the appropriate fee amount is inputted,
c. if the transaction information indicates proximal end payment, then transaction fee is added to the transaction amount by the sender data and money transfer device,
d. if the transaction information indicates distal end payment,
i. if deduct is indicated in the retrieval information, the dispenser data and money transfer device deducts the transaction fee from the transferred funds,
ii. if remit is indicated in the retrieval information, the dispenser data and money transfer device prompts to insert the correct amount into the currency acceptor or coin acceptor.
